(19) United States
(12) Patent Application Publication
(10) Pub. No.: US 2007/0163395 A1
(43) Pub. Date: Jul. 19, 2007

(54) MULTIPURPOSE CONCRETE TOOL

(75) Inventors: Bryson E. Wagner, Yates Center, KS (US); Charles A. Davis, Yates Center, KS (US)

Correspondence Address: HOVEY WILLIAMS LLP, 2405 GRAND BLVD., SUITE 400, KANSAS CITY, MO, 64108, US

(73) Assignee: WILDCAT CONCRETE & CONSTRUCTION LLC, Yates Center, KS (US)

(21) Appl. No.: 11/307,037

(22) Filed: Jan. 19, 2006

(51) Int. Cl. B25D 1/00

(52) U.S. Cl. 81/20

(57) ABSTRACT

A multipurpose concrete form tool (10) is provided which is designed to facilitate assembly and disassembly of concrete forms made up of side-by-side form panels (40). The tool (10) includes a primary handle (12), an upper hammer head (14) having a striking section (22) and a rearward claw section (24), and a lower, transversely oriented auxiliary handle (16). The striking section (22) presents a substantially flat striking surface (28) as well as rearwardly extending, top and lateral surfaces (30, 32, 34), which are also substantially flat and perpendicular to the surface (28). The claw section (24) is preferably of unitary, imperforate construction, presenting a rearmost solid claw surface (36). The tool (10) facilitates attachment and detachment of form panel-connecting wedge pins (50, 52), manipulation of individual form sections (40), and removal of residual concrete (54).

### BACKGROUND OF THE INVENTION

1. Field of the Invention

The present invention is broadly concerned with concrete tools and accessories used in connection with fabricating concrete bodies, such as house or building foundations. More particular, the present invention is concerned with an improved, multipurpose tool, and methods of use thereof, designed to facilitate the assembly and disassembly of multiple-section concrete forms.

2. Description of the Prior Art

Concrete forms are widely use in the fabrication of concrete structures such as foundations. Such forms typically are made up of a plurality of side-by-side interconnected form panel sections, each having a main panel, vertical, slotted side marginal connection flanges, and a series of horizontally extending, slotted flange ribs. The panels are placed in juxtaposition and a series of tapered wedge pins are driven through mated connection flange slots. These horizontally extending wedge pins are then locked in place by driving vertical wedge pins downwardly through the horizontal wedge pin slots and through adjacent flange rib slots. After concrete has been poured into the form and allowed to set, the panel sections must be disassembled and removed for reuse.

A variety of tools have been used in the past during assembly and disassembly of form systems. The most commonly used tool is a conventional hammer, having a rounded striking surface and a rearwardly extending, bifurcated claw. Various levers and pry bars have also been used in manipulation of the panel sections; moreover, some of these sections are equipped with permanent handles in the centers thereof.

These types of common tools have a number of problems when used in the context of concrete form assembly/disassembly. For example, when a worker uses a conventional hammer for wedge pin insertion or detachment, there is a tendency to strike a glancing blow to the wedge pins, rather than striking them cleanly. This is believed to stem from the circular configuration of the hammer striking surface and the overall rounded nature of the hammer head. When such a hammer is used to detach residual concrete from form sections, the bifurcated claw tends to become lodged with the concrete and does not efficiently remove the concrete. Furthermore, there is often difficulty in removing the forms from the formed concrete body. It is not desirable to place pry bars against the body, as damage might occur, and centralized handles on the forms fail to provide the necessary leverage often needed to remove the form from the body. Although release materials (e.g., oil or other lubricants) are often provided on the inside surface of the forms, such techniques only further exacerbate these problems because tools and other equipment can become very slippery.

There is accordingly a need in the art for an improved multiple use tool designed for concrete form work, which efficiently performs the specialized tasks needed in such work and eliminates the need to stock and carry a plurality of different tools.

### SUMMARY OF THE INVENTION

The present invention overcomes the problems outlined above and provides a single tool which has multiple uses, especially in the context of assembly and disassembly of concrete forms.

Broadly speaking, the present invention provides a tool comprising an elongated primary handle presenting a longitudinal axis, with a hammer head adjacent one end of the primary handle and including a forward striking section and a rearward claw section. The forward striking section presents a substantially flat striking surface, along with a top surface and a pair of lateral or side surfaces extending rearwardly from the striking surface. The top surface and at least one of the lateral surfaces are substantially flat and transverse relative to the striking surface. The claw section presents a rearmost, unitary and imperforate claw surface. An elongated auxiliary handle is secured to the primary handle in spaced relationship to the hammer head and is transversely oriented relative to the longitudinal axis of the primary handle.

The tool of the invention is especially adapted to facilitate attachment and detachment of tapered form wedge pins used to interconnect side-by-side form panels. The substantially flat top and lateral surfaces of the striking section can be placed adjacent the panel and the flanges thereof to guide the travel of the tool, thus assuring clean strikes against the wedge pins. Additionally, the claw section can be inserted into form flange slots to assist in placement and removal of individual form panels, and the rearmost end of the claw section can be used to remove residual concrete from the form sections.

In preferred forms, the striking section is configured so that the top and both lateral surfaces are substantially flat and perpendicular relative to the striking surface. The top and lateral surfaces have a width of from about ¼ to 1 inch. The claw section is preferably unitary and imperforate throughout the length thereof.

Another aspect of the present invention concerns a method of detaching concrete form panels from a completed concrete body. The concrete form detachment method includes the step of providing a tool having a primary handle and a head at one end of the primary handle that presents a forward striking section and a rearward claw section. Moreover, the method involves detaching the wedge pins by striking the tapered ends of the wedge pins with the striking section of the tool. The technique further involves using the tool to remove the concrete forms from the completed concrete body. This step includes the steps of inserting the claw section of the tool into one of the flange slots of one of the form panels, and pulling the form panel away from the completed concrete body. Yet further, the method involves removing residual concrete from the form panel with the claw section. In this regard, this aspect of the present invention provides a method of detaching concrete forms that requires the use of only a single tool to detach wedge pins, effectively and assuredly pull the forms from the completed concrete body, and remove residual concrete from the forms.

Other aspects and advantages of the present invention will be apparent from the following detailed description of the preferred embodiments and the accompanying drawing figures.

### BRIEF DESCRIPTION OF THE DRAWING FIGURES

A preferred embodiment of the present invention is described in detail below with reference to the attached drawing figures, wherein:

FIG. 1 is a perspective view of a multipurpose concrete tool constructed in accordance with the principles of a preferred embodiment of the present invention;

FIG. 2 is a front elevation view of the tool;

FIG. 3 is a plan view of the tool;

FIG. 4 is a fragmentary perspective view illustrating use of the tool for detachment of a vertical form wedge pin;

FIG. 5 is a fragmentary perspective view illustrating use of the tool in detachment of a horizontal form wedge pin;

FIG. 6 is a fragmentary perspective view of a concrete form and use of the preferred tool of the invention in stripping the form from a concrete wall;

FIG. 7 is a view similar to that of FIG. 6, but showing the tool during use in pulling a form section from the concrete wall; and

FIG. 8 is a fragmentary perspective view illustrating use of the tool for scraping of concrete waste from a form section.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENT

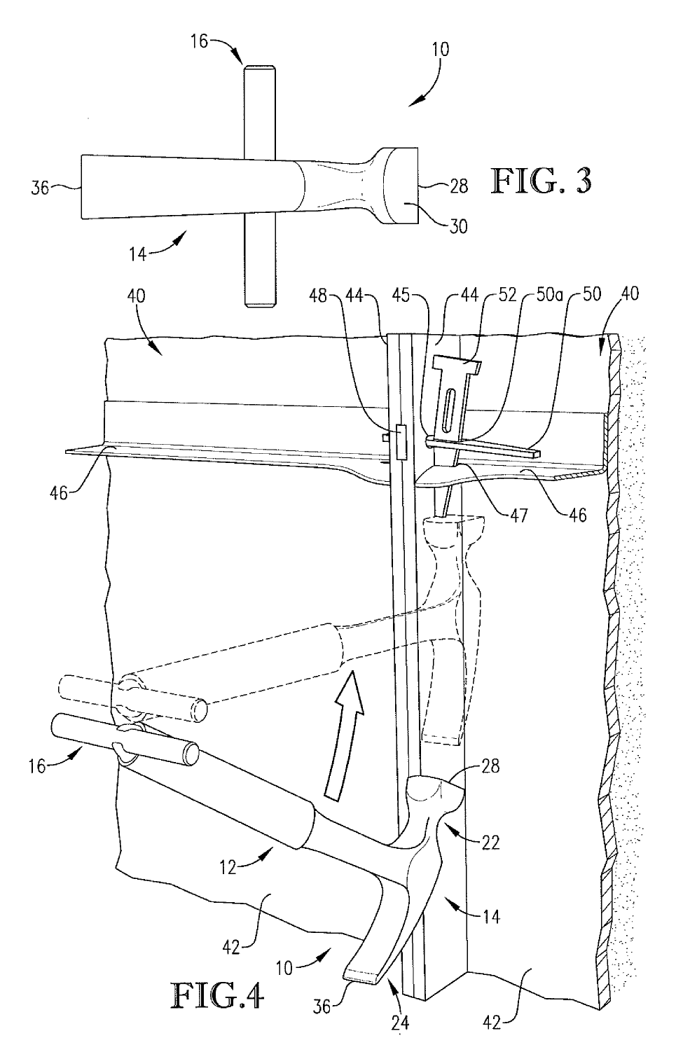

Turning now to the drawings, the multipurpose concrete tool 10 selected for illustration is depicted in FIGS. 1-3. The tool 10 broadly includes an elongated primary handle 12, an uppermost hammer head 14, and a lower auxiliary handle 16 secured to the butt end of primary handle 12. As explained below, the tool 10 is especially designed for use in the erection and disassembly of concrete forms.

In detail, the primary handle 12 is preferably formed of high-grade steel and has a conventional high-friction grip 18 along the lower end thereof between head 14 and auxiliary handle 16. The grip 18 may be formed of resilient, textured synthetic resin material. The portion of primary handle 12 above grip 18 presents a reduced thickness neck 20 leading to head 14.

The head 14 is preferably integrally formed with primary handle 12 and broadly includes a forward striking section 22 and a rearward claw section 24. The handle 12 and head 14 are preferably formed of metal, and most preferably formed of steel. The striking section 22 presents a bulbous body 26 terminating in a substantially flat striking surface 28. In addition, the section 22 has a substantially flat top surface 30 as well as substantially flat side surfaces 32 and 34 extending downwardly from the top surface 30. It will be observed that the surfaces 30-34 are substantially perpendicular relative to striking surface 28. These surfaces typically have a width of from about ¼-1 inch, and more preferably about ½ inch.

The claw section 24 is of arcuate, tapered configuration and presents a rearmost, unitary and imperforate claw surface 36. Preferably, the entire claw section is solid and imperforate as shown; however, an opening may be providing spaced from the surface 36 if desired.

The auxiliary handle 16 is preferably elongated and formed of solid metal. If desired, the auxiliary handle may be formed integrally with the handle 12 and head 14. The auxiliary handle has a rod-like construction and presents a smooth outer surface, although finger-gripping corrugations may be provided if desired. In the illustrated embodiment, the auxiliary handle is secured to the lowermost butt end of handle 12 by weldment 38 or any other appropriate connection.

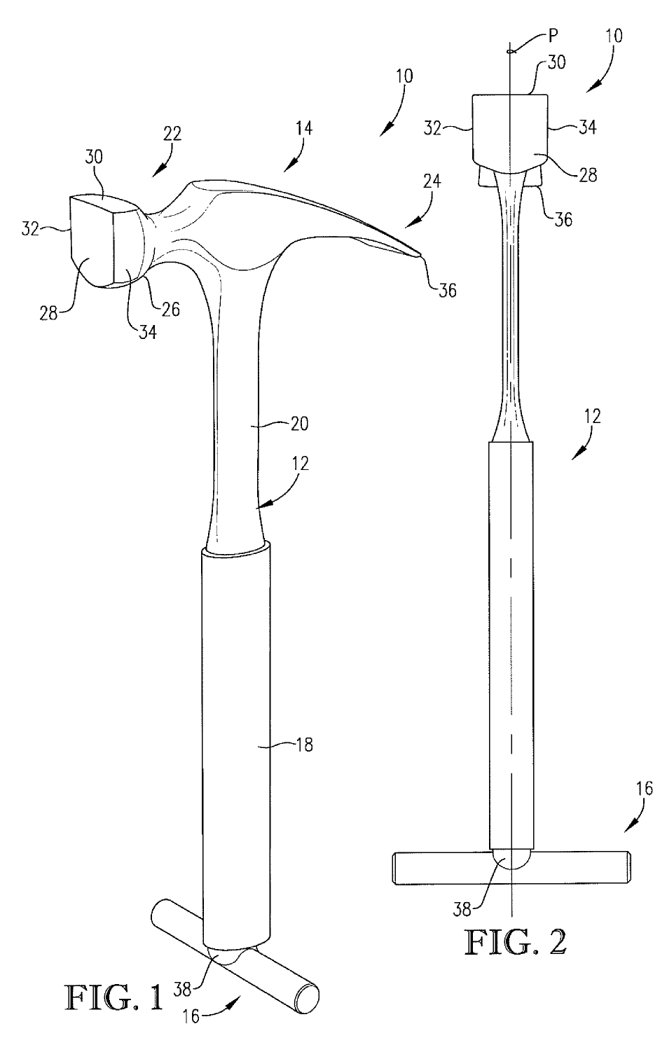

Referring to FIG. 2, it will be seen that the primary handle 12 and head 14 lie in a plane P, whereas the longitudinal axis of auxiliary handle 16 is transversely oriented relative to the plane P, and preferably orthogonal relative to this plane. It will also be seen that the longitudinal axis of handle 16 is transverse (and preferably orthogonal) relative to the longitudinal axis of head 14 extending from face 20 through surface 36.

As indicated, the tool 10 finds special utility in the construction and disassembly of concrete forms, such as those used in the fabrication of foundations or the like. As is well known, these forms are constructed using a plurality of interconnected form panels 40. Such panels 40 are normally fabricated from aluminum and have a flat panel section 42, upright, side marginal connection flanges 44 with connection slots 45 provided at recessed regions 45a, and laterally extending, vertically spaced apart, rib flanges 46 having connection slots 47. The panels 40 are placed in side-by-side orientation with the regions 45a and slots 45 of the adjacent connection flanges 44 in substantial alignment. A series of elongated, form ties 48 having endmost slots 49 are also positioned between the connection flanges at the recessed regions 45a, with the tie slots 49 in registry with the connection flange slots 45. A series of tapered wedge pins 50 having locking slots 50a are then driven into the mated slots 45 and 49. Finally, the driven wedge pins 50 are locked in placed using vertical wedge pins 52 which are driven through the slots 50a of the wedge pins 50, and also through rib slots 47.

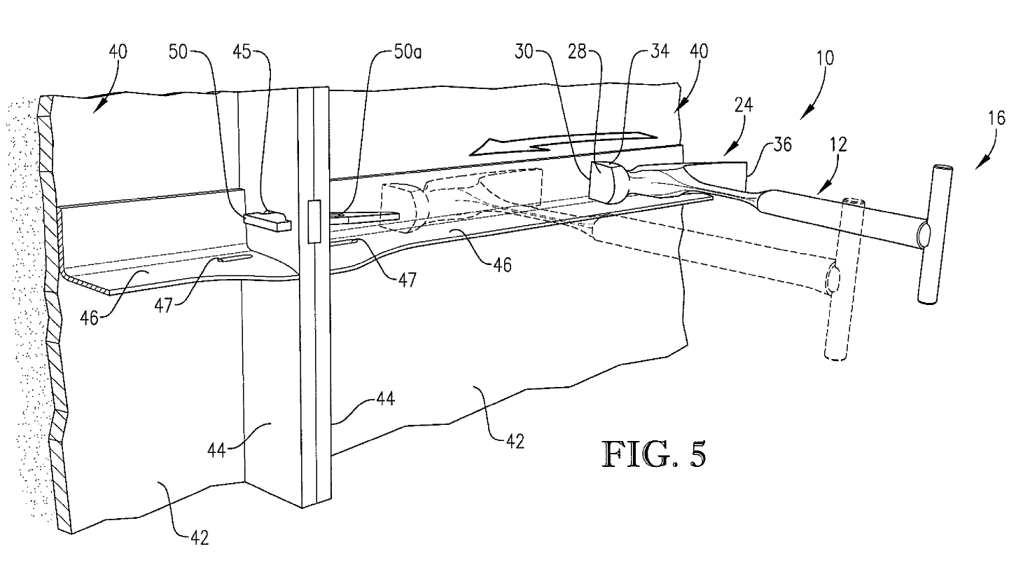

FIGS. 4-8 illustrate use of the tool 10 during disassembly of a system of form panels. In FIG. 4, the tool 10 is shown detaching a vertical wedge pin 52 during the initial stages of form disassembly. As shown, the tool 10 is used by striking upwardly beneath the tapered end of pin 52, so that the contact face 28 strikes the lowered tapered end of the pin. This is facilitated with the tool 10, owing to the presence of the flat top surface 30 and the side surface 32. These surfaces engage the panel 42 and the adjacent surface of the flange 44, with these panel surfaces serving as a guide for directing the striking surface 28 against the wedge pin 52. In the next step (see FIG. 5), the tool 10 is used to detach the horizontal wedge pins 50. Here again, it will be seen that the head 14 of the tool is placed on the flange 46, with top surface 30 engaging panel 42, and with side surface 32 engaging the upper surface of the flange 46. This allows the user to properly guide the tool so that a clean strike against the tapered end of wedge pin 50 is achieved.

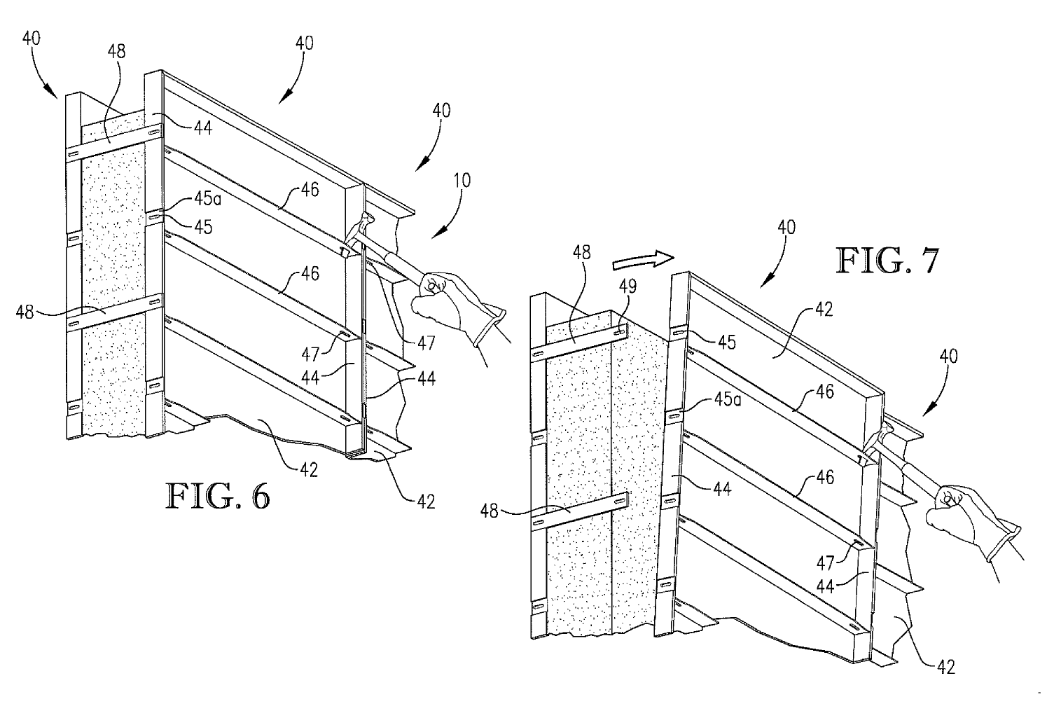

Once the pins 50 and 52 have been removed, the tool 10 can be used to strip the panel sections from the completed concrete structure. This utility is illustrated in FIGS. 6 and 7. In the initial step, the user grasps auxiliary handle 16 and places the claw section 24 into a slot 47 of one of the ribs 46. The user then pulls tool 10 downwardly and outwardly, causing the panel 40 to be readily detached from the formed concrete. It will be appreciated that this mode of panel stripping utilizes the high mechanical advantage obtained by the insertion of claw section 24 into one of the side marginal slots 47. Next, the tool 10 may be used to strike off the apertured ends of the now concrete-embedded form ties 48. This is done, for example, by a simple striking the neck downwardly against the top edge of the exposed tie ends. Of course, the user may alternatively swing the neck upwardly against the bottom edge of the exposed tie ends, or the user may strike one of the flat faces of the exposed tie ends with the striking surface 28.

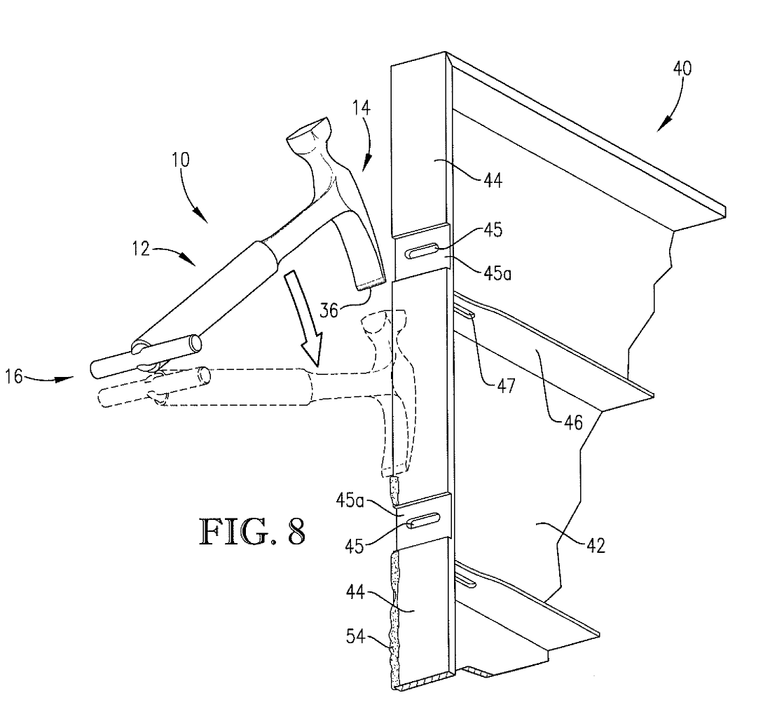

Often, the detached panels 40 are encrusted with residual concrete 54 (see FIG. 8). Tool 10 is useful for removing this residual concrete by scraping (e.g., downwardly) against the form and on the residual concrete with the rearmost claw surface 36. Inasmuch as the surface 36 is unitary and imperforate, the concrete 54 can be easily removed.

While the above description refers to the disassembly of a concrete system, it will be appreciated that tool 10 can also be used during form assembly, particularly in the placement of the wedge pins 50 and 52.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A multipurpose concrete tool comprising:
an elongated primary handle presenting a longitudinal axis;
a hammer head adjacent one end of said primary handle and including a forward striking section and a rearward claw section,
said forward striking section presenting a substantially flat striking surface, a top surface, and a pair of lateral surfaces extending rearwardly from said striking surface,
said top surface and at least one of said lateral surfaces being substantially flat and transverse relative to said striking surface,
said claw section presenting a rearmost, unitary and imperforate claw surface; and
an elongated auxiliary handle secured to said primary handle in spaced relationship to said hammer head and transversely oriented relative to the longitudinal axis of said primary handle.

2. The multipurpose concrete tool as claimed in claim 1,
both of said lateral surfaces being substantially flat.

3. The multipurpose concrete tool as claimed claim 1,
said substantially flat surfaces having a width of from about ¼ to about 1 inch.

4. The multipurpose concrete tool as claimed in claim 3,
said substantially flat surfaces having a width of about 1/2 inch.

5. The multipurpose concrete tool as claimed in claim 1,
said substantially flat surfaces being substantially perpendicular relative to said striking surface.

6. The multipurpose concrete tool as claimed in claim 1,
said claw being unitary and imperforate throughout the length thereof.

7. The multipurpose concrete tool as claimed in claim 1,
said primary handle and hammer head lying in a plane,
said auxiliary handle presenting a longitudinal axis that is substantially orthogonal to said plane.

8. The multipurpose concrete tool as claimed in claim 1,
said hammer head presenting a longitudinal axis extending along the length thereof from said striking section toward said claw,
said longitudinal axis of said auxiliary handle being substantially orthogonal relative to the hammer head longitudinal axis.

9. The multipurpose concrete tool as claimed in claim 1,
said auxiliary handle being secured to the end of said primary handle opposite from said hammer head.

10. The multipurpose concrete tool as claimed in claim 1,
said primary handle and hammer head being integrally formed.

11. The multipurpose concrete tool as claimed in claim 10,
said primary handle and hammer head being formed of steel.

12. The multipurpose concrete tool as claimed in claim 1,
said primary handle including an outermost hand grip between said hammer head and said auxiliary handle.

13. A method of detaching concrete form panels from a completed concrete body, wherein the form panels have slotted connection flanges with tapered form wedge pins extending through adjacent flange slots to interconnect adjacent form panels, said concrete form detachment method comprising the steps of:
(a) providing a tool having a primary handle and a head at one end of the primary handle that presents a forward striking section and a rearward claw section;
(b) detaching the wedge pins by striking the tapered ends of the wedge pins with the striking section of the tool;
(c) using the tool to remove the concrete forms from the completed concrete body, step (c) including the steps of inserting the claw section of the tool into one of the flange slots of one of the form panels, and pulling the form panel away from the completed concrete body; and
(d) removing residual concrete from the form panel with the claw section.

14. The concrete form detachment method as claimed in claim 13,
step (a) including the step of providing the striking section of the tool with a substantially flat striking surface, a top surface, and a pair of lateral surfaces bounding the striking surface, with the top surface and at least one of the lateral surfaces being substantially flat,
step (b) including the step of positioning the top surface and one of the side surfaces in engagement with the panel and a connection flange, and using such engagement between the top surface and one of the side surfaces with the panel and connection flange as a guide during detachment of the pins.

15. The concrete form detachment method as claimed claim 13,
step (a) including the step of providing the claw section with a unitary and imperforate rearmost claw surface,
step (d) including the step of scraping the rearmost claw surface against the concrete form to dislodge the residual concrete therefrom.

16. The concrete form detachment method as claimed in claim 13,
step (c) including the steps of manually grasping an auxiliary handle that is transverse to the primary handle and adjacent an end thereof opposite from the head, and exerting a pulling force on the auxiliary handle after the claw section is inserted in one of the flange slots of the form panel.
